(19) United States
(12) Patent Application Publication
(10) Pub. No.: US 2023/0376784 A1
(43) Pub. Date: Nov. 23, 2023

(54) METHOD, SYSTEM, AND APPARATUS FOR EFFICIENT NEURAL DATA COMPRESSION FOR MACHINE TYPE COMMUNICATIONS VIA KNOWLEDGE DISTILLATION

(71) Applicant: SAMSUNG ELECTRONICS CO., LTD., Suwon-si (KR)

(72) Inventors: Mostafa Ahmed Hassan HUSSEIN, Montreal, CA (US); Yi Tian Xu, Mont-Royal (CA); Di Wu, Montreal (CA); Xue Liu, Montreal (CA); Gregory Lewis Dudek, Westmount (CA)

(73) Assignee: SAMSUNG ELECTRONICS CO., LTD., Suwon-si (KR)

(21) Appl. No.: 18/198,140

(22) Filed: May 16, 2023

Related U.S. Application Data
(60) Provisional application No. 63/344,418, filed on May 20, 2022.

(51) Int. Cl. G06N 3/096; G06N 3/0455

(52) U.S. Cl. CPC G06N 3/096; G06N 3/0455

(57) ABSTRACT

Methods, systems, and apparatuses for managing sensor data, including receiving encoded data at a first device from a second device separate from the first device, wherein the encoded data is generated using an artificial intelligence (AI) encoder model included in the second device based on sensor data collected by at least one sensor included in the second device; providing the encoded data to an AI inference model to obtain inference information; and performing a task based on the inference information, wherein the AI encoder model and the AI inference model are jointly trained based on an output of an AI teacher model

### CROSS-REFERENCE TO RELATED APPLICATION(S)

This application is based on and claims priority under 35 U.S.C. § 119 to U.S. Provisional Patent Application No. 63/344,418, filed on May 20, 2022 in the U.S. Patent & Trademark Office, the disclosure of which is incorporated by reference herein in its entirety.

### BACKGROUND

### 1. Field

The disclosure relates to managing sensor data, and more particularly to neural data compression of sensor data using knowledge distillation.

### 2. Description of Related Art

The International Telecommunication Union (ITU) Radiocommunication Sector (ITU-R) has three main use cases for fifth generation (5G) mobile technology, in particular enhanced mobile broadband (eMBB), ultra-reliable low latency communication (URLLC), and massive machine-type communications (mMTC). Of these use cases, mMTC is intended to support the immense, and ever increasing, traffic volume generated by various applications such as Internet of things (IoT) applications, body area networks, intelligent surveillance systems, smart homes, etc.

An important aspect of supporting mMTC is network energy efficiency, which may refer to the ability of a node to minimize its energy consumption for radio access given a certain traffic capacity. A widely used technique to achieve increased network energy efficiency in loaded cases is data compression.

Many data compression techniques are intended to be used in human type communications (HTC), in which the data is intended for human consumption at one end. Therefore, these data compression techniques may prioritize obtaining an accurate reconstruction. However, in MTC and mMTC, the generated data is intended to be consumed by other machines, for example in order to achieve fully autonomous systems. Therefore, mMTC implementations may benefit from data compression techniques which prioritize inferring accurate decisions.

For example, one or more sensors may be used to monitor an environment for certain phenomena. The sensors may be located in edge nodes of a network which may perceive the environment through a series of observations, and then each sensor may send its sensor data to a central node which fuses the sensor data and infers a decision from this data. Such a setup is common in different fields and applications. Examples include intelligent abandoned object detection in which one or more surveillance cameras monitor a certain space for abandoned objects that may contain hazardous materials, smoke detection in which one or more surveillance cameras or other types of sensors monitor a certain space for smoke, or wearable sensor fusion in which wearable devices are used to detect events associated with a user, such as health events or home automation events.

To prolong the lifetime of the nodes, save bandwidth, and reduce latency, each node may compress the observations before the transmission to the central node. Because the data in MTC and mMTC may be intended to be processed by a machine, for example to infer a consensus about the environment, the inferred decision may be of much more importance than reconstruction accuracy.

Therefore, there is a need for data compression techniques in which the observations are compressed with minimum possible loss in the decision accuracy.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method of managing sensor data includes receiving encoded data at a first device from a second device separate from the first device, wherein the encoded data is generated using an artificial intelligence (AI) encoder model included in the second device based on sensor data collected by at least one sensor included in the second device; providing the encoded data to an AI inference model to obtain inference information; and performing a task based on the inference information, wherein the AI encoder model and the AI inference model are jointly trained based on an output of an AI teacher model.

A size of the AI inference model may be smaller than a size of the AI teacher model.

A size of the encoded data may be smaller than a size of the sensor data.

The method may further include obtaining a plurality of pieces of encoded data at the first device from a plurality of second devices which are separate from the first device, wherein the plurality of pieces of encoded data are generated using a plurality of AI encoder models included in the plurality of second devices; and combining the plurality of pieces of encoded data with the encoded data to generate aggregated data. The inference information may be generated by the AI inference model based on the aggregated data, and the plurality of AI encoder models may be jointly trained with the AI encoder model and the AI inference model based on the output of the AI teacher model.

The encoded data may be quantized by the AI encoder model before being transmitted to the first device.

The second device may include a surveillance camera as the at least one sensor, and the task may include detecting at least one of an object and an event observed by the surveillance camera.

The second device may include a wearable device, and the task may include detecting a health event associated with a user wearing the wearable device.

The second device may include an internet of things (IoT) device, and the encoded data may be received using massive machine-type communications (mMTC).

The AI inference model may include a first neural network model, and the AI teacher model may include at least one from among a second neural network model, a support vector machine (SVM) model, and an ensemble model.

In accordance with an aspect of the disclosure, a device for managing sensor data includes at least one memory storing computer-readable instructions; and at least one processor configured to execute the computer-readable instructions to: receive encoded data at a first device from a second device separate from the first device, wherein the encoded data is generated using an artificial intelligence (AI) encoder model included in the second device based on sensor data collected by at least one sensor included in the second device, provide the encoded data to an AI inference model to obtain inference information, and perform a task based on the inference information, wherein the AI encoder model and the AI inference model are jointly trained based on an output of an AI teacher model.

A size of the AI inference model may be smaller than a size of the AI teacher model.

A size of the encoded data may be smaller than a size of the sensor data.

The the at least one processor may be further configured to execute the computer-readable instructions to: obtain a plurality of pieces of encoded data at the first device from a plurality of second devices which are separate from the first device, wherein the plurality of pieces of encoded data are generated using a plurality of AI encoder models included in the plurality of second devices, and combine the plurality of pieces of encoded data with the encoded data to generate aggregated data, wherein the inference information is generated by the AI inference model based on the aggregated data, and wherein the plurality of AI encoder models are jointly trained with the AI encoder model and the AI inference model based on the output of the AI teacher model.

The encoded data may be quantized by the AI encoder model before being transmitted to the first device.

The second device may include a surveillance camera as the at least one sensor, and the task may include detecting at least one of an object and an event observed by the surveillance camera.

The second device may include a wearable device, and the task may include detecting a health event associated with a user wearing the wearable device.

The second device may include an internet of things (IoT) device, and the encoded data may be received using massive machine-type communications (mMTC).

The AI inference model may include a first neural network model, and the AI teacher model may include at least one from among a second neural network model, a support vector machine (SVM) model, and an ensemble model.

In accordance with an aspect of the disclosure, a non-transitory computer-readable storage medium stores instructions which, when executed by at least one processor of a device for managing sensor data, causes the at least one processor to: receive encoded data at a first device from a second device separate from the first device, wherein the encoded data is generated using an artificial intelligence (AI) encoder model included in the second device based on sensor data collected by at least one sensor included in the second device; provide the encoded data to an AI inference model to obtain inference information; and perform a task based on the inference information, wherein the AI encoder model and the AI inference model are jointly trained based on an output of an AI teacher model.

A size of the AI inference model is smaller than a size of the AI teacher model, and wherein a size of the encoded data is smaller than a size of the sensor data.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of a system for managing sensor data according to embodiments;

FIG. 2 is a diagram illustrating an example structure of an autoencoder according to embodiments;

FIG. 3 is a diagram illustrating a system for training a student model according to embodiments;

FIG. 4 is a diagram illustrating an example of data quantization according to embodiments;

FIG. 5 is a diagram illustrating a system for jointly training a distillation encoder and an inference model according to embodiments;

FIG. 6A is a flowchart illustrating an overall process of training a teacher model, a distillation encoder, and an inference network to manage sensor data according to embodiments;

FIG. 6B is a flowchart illustrating a process of jointly training a distillation encoder and an inference model according to embodiments;

FIG. 7 is a flowchart of a process for using an inference model to perform a task based on data received from a distillation encoder.

FIGS. 8A to 8C are diagrams illustrating examples of use applications for a distillation encoder and an inference model according to embodiments;

FIGS. 9A to 9C illustrate example data sets used to test a distillation encoder and an inference model according to embodiments;

FIG. 9D illustrates example results of using a distillation encoder and an inference model to perform classification tasks according to embodiments; and

FIG. 10 is a block diagram of an electronic device according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

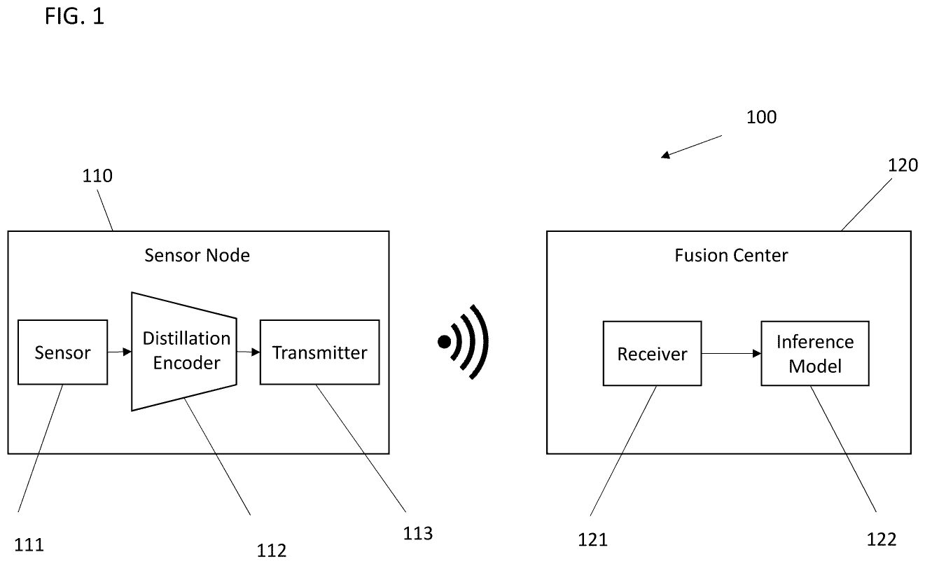

FIG. 1 is a diagram showing a general overview of a system for managing sensor data according to embodiments.

FIG. 1 is a diagram showing a general overview of a system 100 for predicting future loads according to embodiments. The system 100 may be a distributed inference network which may be used to perform tasks based on sensor data. For example, the system 100 may be used to make decisions or generate alerts or notifications based on events or objects detected using the sensor data.

The system 100 may include a sensor node 110 and a fusion center 120. Although FIG. 1 illustrates only one sensor node 110, embodiments are not limited thereto, and the system 100 may include a plurality of sensor nodes 110. The sensor node 110 may transmit sensor data to the fusion center 120, and the fusion center 120 may perform tasks such as making the decisions or generating the alerts or notifications based on objects, activities, and/or events detected by the sensor node 110.

The sensor node 110 may be any device which is capable of obtaining sensor data, such as a surveillance camera, a wearable device, an edge device, and the like. In embodiments, the sensor node 110 may be, for example, an Internet of Things (IoT) device. The sensor node 110 may include a sensor 111, a distillation encoder 112, and a transmitter 113. The sensor 111 may be any type of sensor, such as an image sensor, a microphone, an accelerometer, a gyroscope, a magnetometer, a location sensor such as a global positioning system (GPS) sensor, a heart rate sensor, a pedometer, a motion sensor, a pressure sensor, and the like. For example, based on the sensor node 110 being a surveillance camera, the sensor 111 may include an image sensor and/or a microphone. As another example, based on the sensor node 110 being a wearable device, the sensor 111 may include at least one of a GPS sensor, an accelerometer, a heart rate sensor, and/or a pedometer. As yet another example, based on the sensor node 110 being a security sensor, the sensor 111 may include a motion sensor and/or a pressure sensor. The distillation encoder 112 may receive raw sensor data from the sensor 111, and may encode the raw data to generate encoded sensor data, for example as codewords. The transmitter 113 may be a wired or wireless transmitter which may transmit the encoded sensor data to the fusion center 120. For example, the transmitter 113 may transmit the encoded sensor data using massive machine-type communications (mMTC).

The fusion center 120 may be a central node of the distributed inference network included in the system 100. The fusion center 120 may include a receiver 121 and an inference model 122. The receiver 121 may be a wired or wireless receiver which may receive the encoded sensor data from the sensor node 110. The inference model 122 may process the encoded sensor data to generate inference information which may be used to perform tasks such as making decisions or generating alerts or notifications. For example, based on the sensor node 110 being a surveillance camera, the inference model 122 may generate inference information which indicates objects, activities, and/or events detected by the surveillance camera, for example abandoned objects, and the fusion center 120 may generate a notification or alert based on the inference information. As another example, based on the sensor node 110 being a wearable device, the inference model 122 may generate inference information about an environment of a user who is wearing the wearable device, for example information about a location of the user or a health event of the user, and the fusion center may generate a notification or alert based on the inference information, or may perform a task such as a home automation task based on the inference information. As yet another example, based on the sensor node 110 being a security sensor, the inference model 122 may generate inference information about a security state of a facility or a home, and may trigger an alarm based on the inference information.

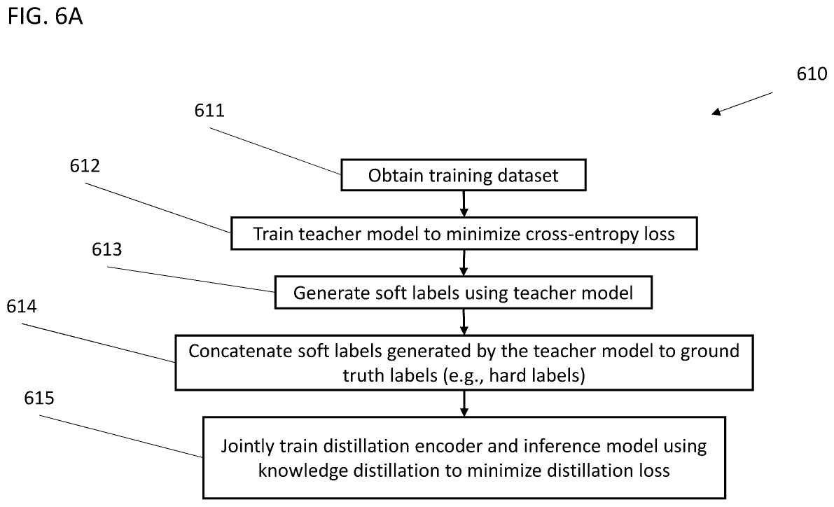

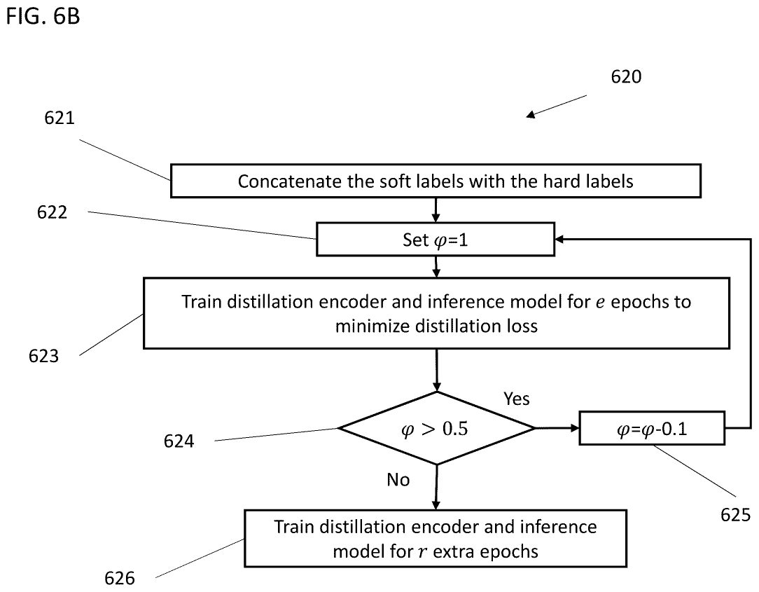

In embodiments, the distillation encoder 112 and the inference model 122 may be artificial intelligence (AI) models, for example neural network models or machine learning models. In embodiments, the distillation encoder 112 and the inference model 122 may be jointly trained, for example using a knowledge distillation process based on the output of a teacher model. An example of a training process for training the distillation encoder 112 and the inference model 122 is described below with reference to FIGS. 6A and 6B.

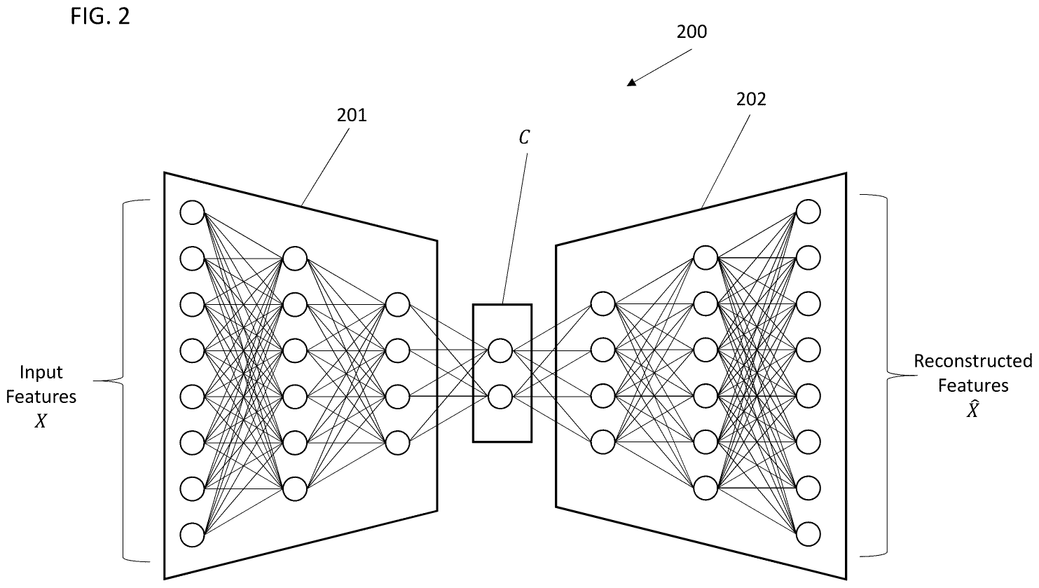

FIG. 2 is a diagram illustrating an example structure of an autoencoder according to embodiments.

As shown in FIG. 2, an autoencoder 200 may be a neural network architecture that includes an encoder model 201 and an decoder model 202. The encoder model 201 may nonlinearly transform the input data X into a lower-dimensional codeword C. The space of the encoded codeword C may be referred to as a latent space, which may be lower-dimensional than the input space. The decoder model 202 may then decode the codeword C to reconstruct the original input data X, for example by generating reconstructed data \hat{X}. Autoencoders may be used to compress and decompress data such as images, videos, wireless channels, bio-signals, or brain-computer interaction data.

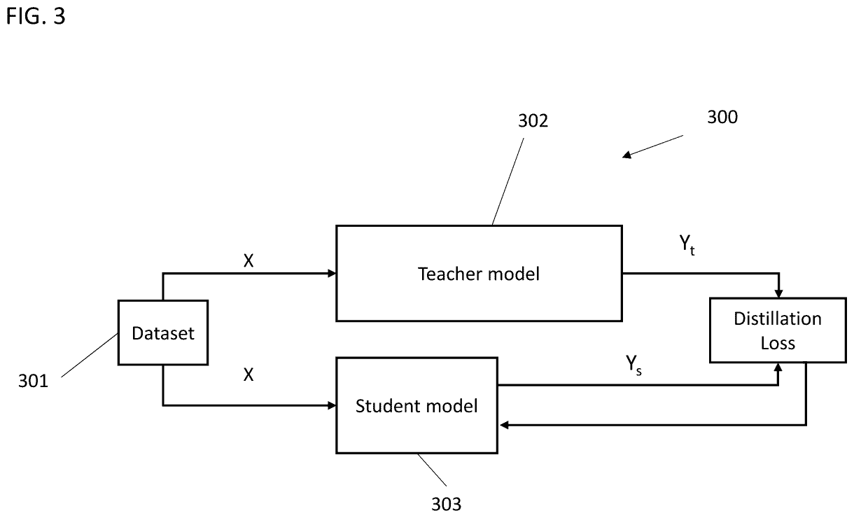

FIG. 3 is a diagram illustrating a system for training a student model using knowledge distillation according to embodiments.

As shown in FIG. 3, the system 300 may include a training dataset 301, and a student model 303, and a teacher model 302. In embodiments, the dataset 301 may include raw data X and ground truth Y, which may be used to train the teacher model 302, and may further be used to calculate a distillation loss which may be used to train the student model 303.

Knowledge distillation is a model training technique that may be used to distill the knowledge of a large and powerful model, for example the teacher model 302, to a smaller and less powerful model, for example the student model 303. Using knowledge distillation, the student model 303 may be trained to mimic the behavior of the teacher model 302. While the teacher model 302 consumes high computational and power resources, which hinders its deployment to resource-constrained edge devices such as the sensor node 110, the student model 303 may be lighter and more easily deployed. Therefore, knowledge distillation may be used to compress cumbersome models to obtain smaller models that can be deployed to resource-limited edge devices without considerable loss in the model performance. Knowledge distillation may be used in many fields, for example object detection, semantic segmentation, and the like.

As shown in FIG. 3, the student model may be trained using a distillation loss, which may be calculated using the ground truth data Y, the output of the teacher model Yₜ generated based on the raw input data X, and the output of the student model Yₛ generated based on the raw input data X. For example, an objective function for the student model 303 can be formulated as a convex combination between a task loss and a knowledge distillation loss. In embodiments, the distillation loss may be expressed according to Equation 1 below:

L(yᵢ,yᵢ^{s})=(φCE(yᵢ,yᵢ^{s})+(1−φ)KL(yᵢ^{s},yᵢ^{t}) (Equation 1)

In Equation 1, yᵢ denotes the ground truth of the ith data point in the dataset 301, yᵢ^{s} denotes the output of the student model 303 for the ith data point, yᵢ^{t}, denotes the output of the teacher model 302 for the ith data point, φ denotes a weight term that controls that contribution of each term in the final loss, CE denotes a cross-entropy loss, and KL denotes a Kullback-Leibler divergence. In embodiments, the ground truth in the dataset 301 may be referred to as hard labels, or one-hot encoded labels, and the output of the teacher model 302 may be referred to as soft labels. In embodiments, φ∈[0,1].

The cross-entropy loss CE may be an example of a task loss for classification tasks. In embodiments, the cross-entropy loss CE may be determined according to Equation 2 below, in which N denotes the number of classes:

CE(y,y^{s})=Σᵢ₌₁^{N}=yᵢ log(yᵢ^{s}) Equation 2

Accordingly, the cross-entropy loss CE for the ith data point may be expressed according to Equation 3 below:

CE(yᵢ,yᵢ^{s}=yᵢ log(yᵢ^{s}) Equation 3

The Kullback-Leibler divergence KL may be an example of a knowledge distillation loss. In embodiments, the Kullback-Leibler divergence KL may be determined according to Equation 4 below:

$$K L ( {Y}_{s} \vert \vert {Y}_{t} ) = {\sum }_{i = 1}^{N} {Y}_{s} ( i ) log ( \frac{{Y}_{s} ( i )}{{Y}_{t} ( i )} ) \qquad Equation 4$$

In Equation 4, Yₛ denotes a distribution of the predictions of the student model 303, and Yₜ denotes a distribution of the predictions of the teacher model 302.

Accordingly, the Kullback-Leibler divergence KL for the ith data point may be expressed according to Equation 5 below:

$$K L ( {y}_{i}^{s} , {y}_{i}^{t} ) = {y}_{i}^{s} log ( \frac{{y}_{i}^{s}}{{y}_{i}^{t}} ) \qquad Equation 5$$

In embodiments, Yₜ may be referred to as soft labels, and may be the output of a Softmax layer which may be included in the teacher model 302. For example, the Softmax layer may convert a logit gᵢ generated by the teacher model 302 for each class to a probability qᵢ for each class according to Equation 6 below:

$${q}_{i} = \frac{{e}^{\frac{{g}_{i}}{T}}}{{\sum }_{j} {e}^{\frac{{g}_{j}}{T}}} \qquad Equation 6$$

In Equation 6 above, T may denote a temperature that controls the softness of the generated distribution. Generally, T may be set to 1, and higher values of T may generate a softer probability distribution over classes. These soft labels may contain information about the correlation between classes, which may not be included in the ground truth hard labels (e.g., the one-hot encoded labels).

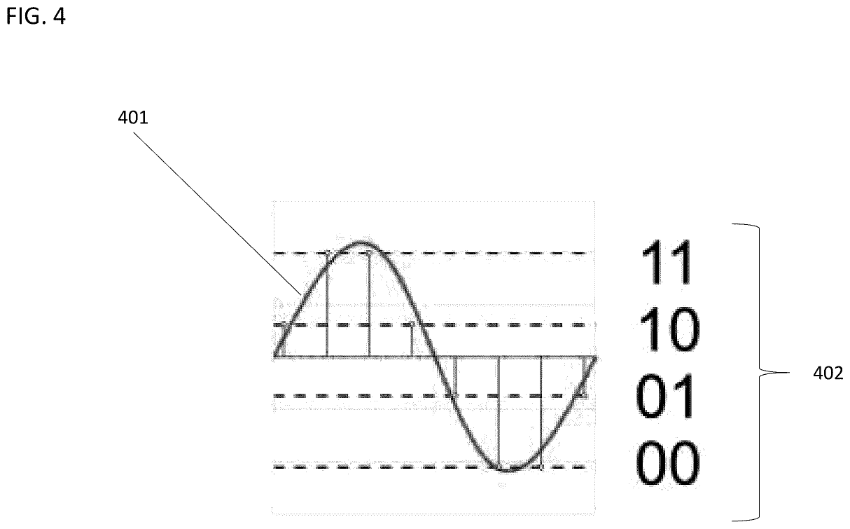

FIG. 4 is a diagram illustrating an example of data quantization according to embodiments.

Quantization may refer to a process of mapping input values from a large set, for example a continuous set which may be infinite, to output values in a countable smaller set, for example a set with a countable or finite number of elements. Accordingly, a quantizer may refer to a certain input/output functional mapping which may be used to implement or perform a quantization process on input data.

Quantized data may be more efficient for transfer between machines than unquantized data. Quantization may also be used in deep learning to help accelerate inference and to reduce memory and power consumption on embedded devices.

Some examples of quantization include rounding and truncation. For example, quantized random projections of data may be sent to a cloud server. The random projections may offer a rate-efficient representation and a time-efficient computation with negligible performance loss for downstream tasks.

According to the example illustrated in FIG. 4, real values of a continuous signal 401 are converted into words 402 having a length of 2 bits.

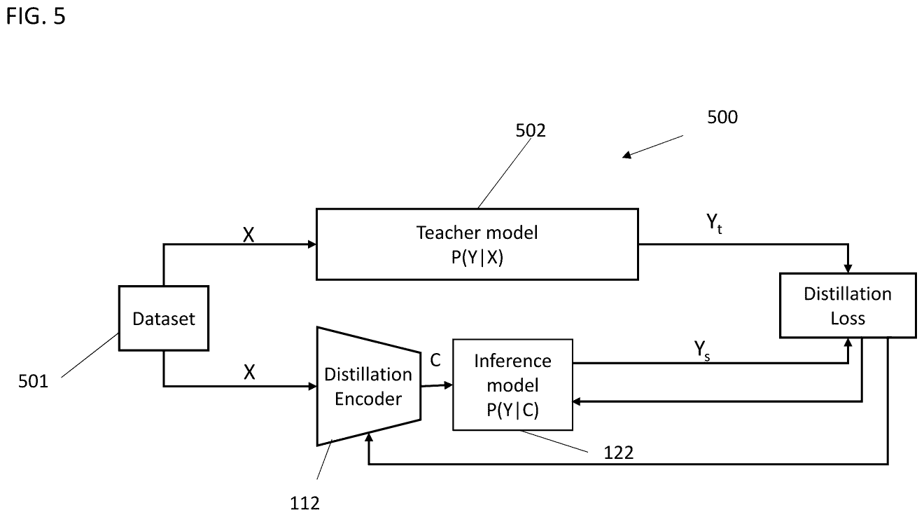

FIG. 5 is a diagram illustrating a system for jointly training a distillation encoder and an inference model according to embodiments.

As shown in FIG. 5, a system 500 may include a dataset 501 and a teacher model 502, the distillation encoder 112 and the inference model 122. In embodiments, the dataset 501 may include raw data X and ground truth Y, which may be used to train the teacher model 502, and may further be used to calculate a distillation loss which may be used to train the distillation encoder 112 and the inference model 122.

In embodiments, the system 500 may be similar to the system 300, except instead of the student model 303, the system 500 may include the distillation encoder 112 and the inference model 122. In embodiments, the distillation encoder 112 and the inference model 122 may be jointly trained using the distillation loss, which may be calculated using the dataset 501 and the output of the teacher model 502. For example, in embodiments the distillation loss may be calculated using Equation 1, where yᵢ may denote the ground truth of the ith data point in the dataset 501, yᵢ^{s} may denote the output of the inference model 122 for the ith data point (which may be generated based on the output of the distillation encoder 112 based on the ith data point), and yᵢ^{t}, may denote the output of the teacher model 502 for the ith data point.

In embodiments, the joint training of the distillation encoder 112 with the inference model 122 may allow the system 100 to minimize false predictions at the fusion center 120. For example, the inference model 122 may inherit the knowledge of the teacher model 502 which is trained to infer a decision based on raw data without compression. In this case, the teacher model 502 may be a knowledgeable model trained to infer decisions given the full knowledge of the data, for example by predicting a conditional probability P(Y|X), where Y denotes the target labels, and X denotes the raw input data. The inference model 122 may be trained to infer the decisions given only partial information, for example by predicting a conditional probability P(Y|C), where C is compressed data generated by the distillation encoder 112 based on the raw input data X.

When the knowledge captured by the teacher model 502 is distilled to the inference model 122, the distillation encoder 112 can learn to encode features that are most relevant for the inference model 122 to maximize its accuracy, and the raw input data can therefore be compressed with the minimum possible loss in the prediction accuracy. As a result, the conditional distribution P(Y|C)can be close to the conditional distribution P(Y|X).

Therefore, in contrast with the knowledge distillation technique discussed above with respect to FIG. 3, the input to the teacher model 502 may be much larger than the input to the inference model 122, which may operate based on the compressed input provided by the distillation encoder 112. As a result, the inference model 122 may generalize like the teacher model 502 by minimizing the KL-divergence between the probability distributions generated by the teacher model 502 and the inference model 122, even though the inference model may be smaller and/or less resource-intensive than the teacher model 502, and may operate on input that may be less resource-intensive to generate, transmit, and/or store than the raw input data used by the teacher model 502.

In embodiments, the teacher model 502 may be any type of model, for example any type of AI model and/or ML model. For example, the teacher model may be, or may include, a neural network (NN) of any architecture, a support vector machine (SVM), an ensemble model, a random forests (RF) model, or any other type of model which can be used to generate the soft labels.

In embodiments, the teacher model 502 may instead be trained on a compressed dataset. For example, compressed data X_{c} corresponding to the raw input data X can be generated using an encoder, to generate compressed data X_{c}. Therefore, rather than being trained to predict the conditional distribution P(Y|X), the teacher model 502 may be trained to predict a conditional distribution P(Y|X_{c}). In embodiments, the distillation encoder 112 may be a quantized encoder which may generate quantized output which is provided to the inference model 122. For example, the distillation encoder 112 may be configured to generate quantized codewords Z, which are included in a set of discrete finite values (e.g., Z e {0,1}1n), rather than codewords C, which are included in a set of continuous infinite values (e.g., C∈Rⁿ). Accordingly, rather than being trained to predict the conditional distribution P(Y|C), the inference model 122 may be trained to predict a conditional distribution P(Y|Z).

In embodiments, the teacher model 502 may be pre-trained, and the output of the teacher model 502 may be obtained before the training of the distillation encoder 112 and the inference model 122. For example, in embodiments the conditional distribution P(Y|X) (or the conditional distribution P(Y|X_{c})), may be obtained in advance and may be included in, or stored in addition to, the dataset 501. Therefore, the distillation encoder 112 and the inference model 122 may be trained based on the dataset 501 and the pre-stored conditional distribution P(Y|X) (or the conditional distribution P(Y|X_{c})).

Therefore, the distillation encoder 112 may achieve high compression ratios while preserving the accuracy of the inferred decisions made by the inference model 122, in contrast with other where data compression techniques which prioritize high reconstruction accuracy. Accordingly, the distillation encoder 112 may be useful for performing data compression and/or quantization in mMTC communications, and embodiments may leverage knowledge distillation to efficiently compress and/or quantize sensor data.

Although FIG. 5 illustrates only one distillation encoder 112, embodiments are not limited thereto, and the system 500 may be used to train the inference model 122 using the combined or aggregated output of a plurality of distillation encoders 112. For example, each of a plurality of distillation encoders 112 may receive some or all of the raw input data X, and may generate corresponding codewords C (or quantized codewords Z).

FIG. 6A is a flowchart illustrating an overall process of training a teacher model, a distillation encoder, and an inference network to manage sensor data according to embodiments.

In operation 611, the process 610 may include obtaining the training dataset. In embodiments, the training dataset may correspond to dataset 501, which may include the raw input data X and the ground truth Y.

In operation 612, the process 610 may include training a teacher model to minimize cross-entropy loss with respect to the training dataset. For example, As discussed above, in some embodiments the teacher model 502 may be trained using the raw input data X. In some embodiments, the teacher model 502 may be trained based on a compressed version of the input data X.

In operation 613, the process 610 may include generating soft labels using the teacher model. For example, after convergence of the teacher model 502, the trained teacher model 502 may be used to generate the soft labels Yₜ based on the dataset 501.

In operation 614, the process 610 may include concatenating the soft labels generated by the teacher model with the ground truth labels.

In operation 615, the process 610 may include jointly training a distillation encoder and an inference model using knowledge distillation to minimize distillation loss.

In embodiments, the distillation encoder may correspond to the distillation encoder 112, and the inference model may correspond to the inference model 122. The distillation loss may be calculated according to Equation 1 above. As discussed above, in some embodiments the distillation encoder 112 may be, or may include, a quantization encoder, and the inference model 122 may be trained using a quantized version of the input data X.

FIG. 6B is a flowchart illustrating a process of jointly training a distillation encoder and an inference model according to embodiments. In an embodiment, one or more of operation 614 and operation 615 in FIG. 6A may include one or more of operations 621-626 in FIG. 6B.

In operation 621, the process 620 may include concatenating the soft labels with the ground-truth hard labels. In embodiments, operation 621 may correspond to operation 614 in FIG. 6A.

In operation 622, the process 620 may include setting the weight term φ equal to 1.

In operation 623, the process 620 may include training a distillation encoder and an inference model to minimize a distillation loss for e epochs. In embodiments, the distillation loss may be calculated according to Equation 1 above.

In operation 624, the process 620 may include determining whether φ is greater than 0.5.

Based on determining that φ is greater than 0.5 (e.g., YES at operation 624), the process 620 may return to operation 622.

Based on determining that φ is not greater than 0.5 (e.g. NO at operation 624), the process 620 may proceed to operation 626, which may include training the distillation encoder and the inference model to minimize a distillation loss for r additional epochs. After operation 626, the training of the distillation encoder and the inference model may be complete.

In embodiments, one or more of the process 610 and the process 620 may be referred to as a training phase for the distillation encoder 112 and the inference model 122. In the training phase, the knowledge of the teacher model 502 may be distilled to the inference model 122, operated based on a compressed and/or quantized version of the raw data which may be provided by the distillation encoder 112.

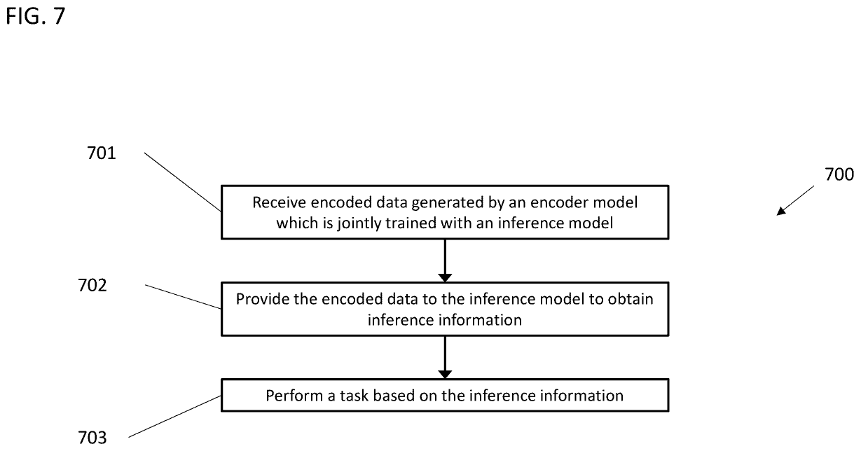

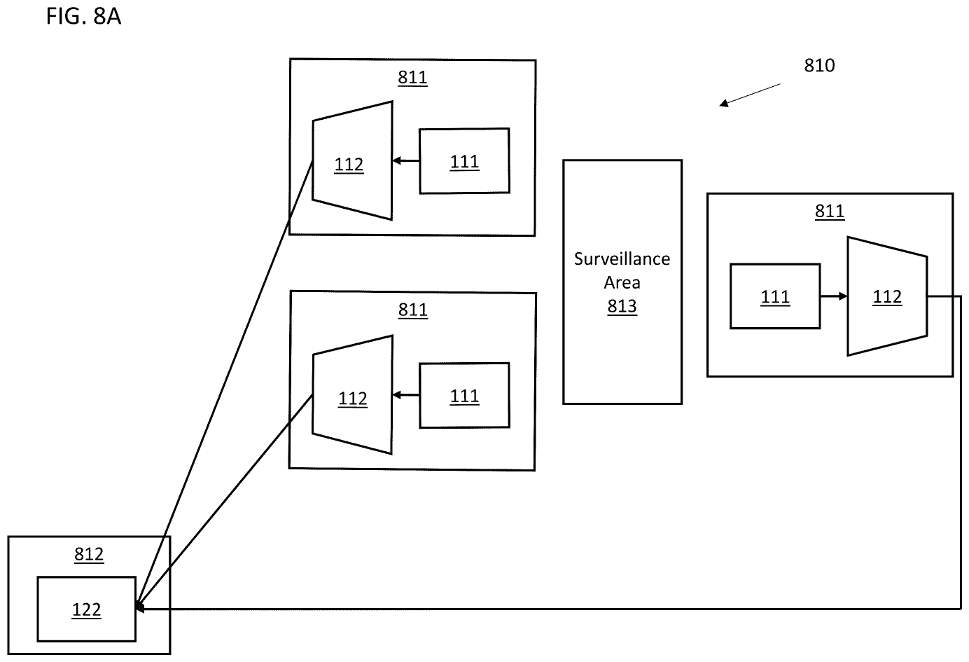

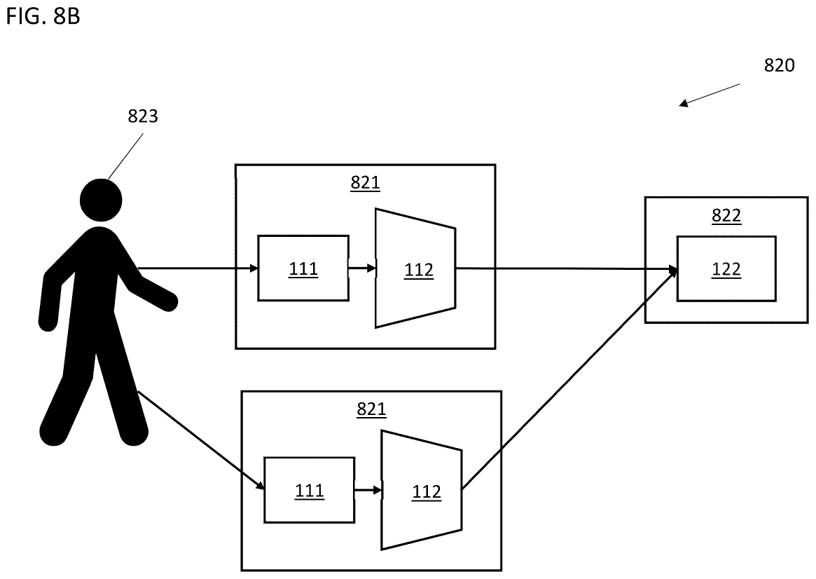

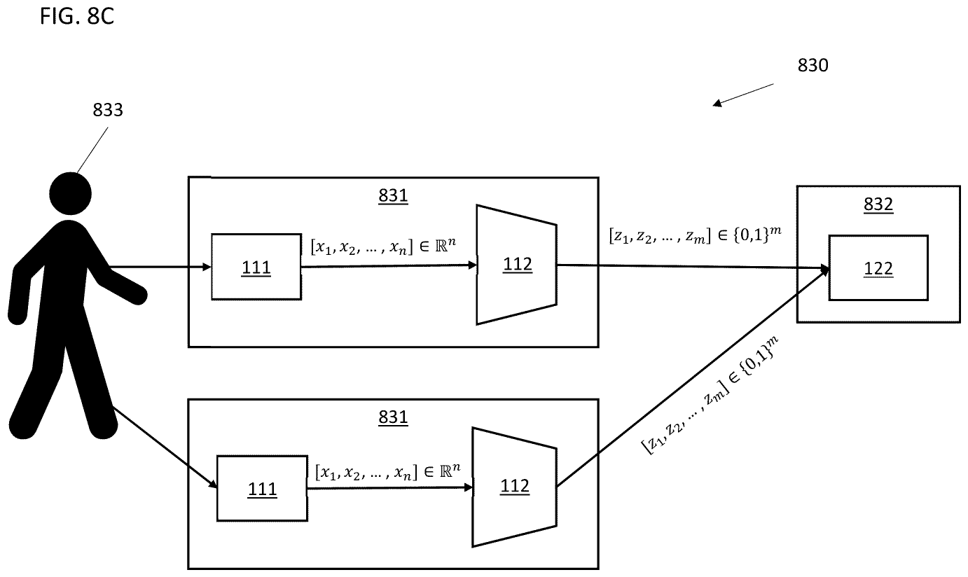

After training, the distillation encoder 112 and the inference model 122 may be deployed to assist in managing sensor data, which may be referred to as a deployment phase. For example, in the deployment phase, the distillation encoder 112 may be deployed at the sensor nodes 110, while the inference model 122 may be deployed at the fusion center 120. Examples of the deployment phase are discussed in more detail below with reference to FIGS. 7 and 8A to 8C.

FIG. 7 is a flowchart of a process for using an inference model to perform a task based on data received from a distillation encoder.

In operation 701, the process 700 may include receiving encoded data at a first device from a second device.

In embodiments, the first device may refer to the fusion center 120 and the second device may refer to the sensor node 110. The encoded data may be generated by an encoder model, which may correspond to may correspond to the distillation encoder 112, and which may be jointly trained with an inference model, which may correspond to the inference model 122. The encoded data may refer to at least one of the codeword C and the quantized codeword Z, which may be generated using the encoder model based on sensor data collected by at least one sensor included in the second device. The joint training may refer to at least one of the process 610 and the process 620 discussed above.

In operation 702, the process 700 may include providing the encoded data to the inference model to obtain inference information. In embodiments, the inference information may refer to an output of the inference model 122. In embodiments, the inference information may indicate a decision or a result obtained by the inference model 122, which may be used to trigger or perform a task.

In operation 703, the process 700 may include performing a task based on the inference information. In embodiments, the task may be, or may include, making a decision or generating an alert or notification based on an event, activity, or object detected using the sensor data.

In embodiments, a size of the inference model may be smaller than a size of the teacher model.

In embodiments, a size of the encoded data may be smaller than a size of the sensor data.

In embodiments, the process 700 may further include obtaining a plurality of pieces of encoded data at the first device from a plurality of second devices which are separate from the first device. The plurality of pieces of encoded data may be generated using a plurality of encoder models included in the plurality of second devices. The plurality of encoder models may be jointly trained with the encoder model and the inference model based on the output of the teacher model.

In embodiments, the process 700 may further include combining the plurality of pieces of encoded data with the encoded data to generate aggregated data. The inference information may be generated by the AI inference model based on the aggregated data.

In embodiments, the encoded data may be quantized by the encoder model before being transmitted to the first device.

In embodiments, the second device may include a surveillance camera as the at least one sensor, and the task may include detecting at least one of an object and an event observed by the surveillance camera.

In embodiments, the second device may include a wearable device, and the task comprises detecting a health event associated with a user wearing the wearable device.

In embodiments, the second device may include an IoT device, and the encoded data may be received using mMTC.

Examples of use applications in which the distillation encoder 112 and the inference model 122 may be deployed are discussed in greater detail below with reference to FIGS. 8A to 8C.

FIG. 8A illustrates a use application in which a plurality of distillation encoders and an inference model are deployed in a surveillance network.

As shown in FIG. 8A, use application 810 may include a plurality of surveillance cameras 811 and a fusion center 812. Each of the surveillance cameras 811 may correspond to a sensor node 110, and may include a distillation encoder 112 and a sensor 111, which may be for example at least one of an image sensor, a microphone, a motion sensor, and the like. The fusion center 812 may correspond to the fusion center 120, and may include an inference model 122 which is jointly trained with the distillation encoders 112 included in the surveillance cameras 811.

The surveillance cameras 811 may be used to monitor a surveillance area 813, and may provide encoded data to the fusion center 812. The encoded data may be generated by the distillation encoders 112 based on raw sensor data captured by the sensors 111. The inference model 122 may generate inference information based on the encoded data, which may be used to perform a task associated with the surveillance cameras 811. For example, the inference information may be information which indicates that an activity, event, or object is present or has occurred in the surveillance area 813, and the task may include at least one of detecting the activity, event, or object, generating an alert, alarm, or notification corresponding to the activity, event, or object, and performing some other action corresponding to the activity, event, or object.

In embodiments, the encoded data may be smaller in size than the raw sensor data. Accordingly, the bandwidth, transmission power, and/or the storage space used by the surveillance cameras 811 may be reduced.

In embodiments, automating the task of surveilling critical spaces such as the surveillance area 813 using the surveillance cameras 811 and the fusion center 812 may save human resources and cost. In addition, the automated surveillance may be more accurate that human-based surveillance. For example, the automated surveillance provided by the surveillance cameras 811 and the fusion center 812 may be used to detect abandoned objects such as abandoned bags in airports, or to detect events such as a fire or entry of unauthorized personnel into the surveillance area 813.

FIG. 8B illustrates a use application in which a plurality of distillation encoders and an inference model are deployed in a body area network.

As shown in FIG. 8B, use application 820 may include a plurality of wearable devices 821 and a fusion center 822. Each of the wearable devices 821 may correspond to a sensor node 110, and may include a distillation encoder 112 and a sensor 111, which may be for example a heart rate sensor, a location sensor, an accelerometer, and the like. The fusion center 822 may correspond to the fusion center 120, and may include an inference model 122 which is jointly trained with the distillation encoders 112 included in the wearable devices 821.

In embodiments, the encoded data may be smaller in size than the raw sensor data. Accordingly, the bandwidth, transmission power, and/or the storage space used by the wearable devices 821 may be reduced.

The wearable devices 821 may worn by a user 823, and may provide encoded data to the fusion center 822. The encoded data may be generated by the distillation encoders 112 based on raw sensor data captured by the sensors 111. The inference model 122 may generate inference information based on the encoded data, which may be used to perform a task associated with the wearable devices 821. For example, the inference information may be information which indicates that an activity or event associated with the user 823 has occurred, and the task may include at least one of detecting the activity or event, generating an alert, alarm, or notification corresponding to the activity or event, and performing some other action corresponding to the activity, event, or object. For example, the use application 820 may be used to generate health alerts relating to the user 823, or to perform home automation tasks corresponding to the user 823.

FIG. 8C illustrates a use application involving a plurality of quantized distillation encoders.

As shown in FIG. 8C, use application 830 may include a plurality of wearable devices 831 and a fusion center 832. Use application 830 may be similar to use application 820, except that the wearable devices 831 may transmit encoded data which is quantized. For example, based on raw input data X=[x₁, x₂, . . . , xₙ] e Rⁿ received from the sensors 111 included in the wearable devices 831, the distillation encoder 112 included in the wearable devices 831 may generate quantized encoded data Z=[z₁, z₂, . . . , zₘ] ∈{0,1}^{m}. In embodiments, the quantized encoded data can be transmitted to the fusion center 832 in real time, or it can be stored locally to be sent or retrieved at a later time.

In embodiments, the quantized encoded data may be smaller in size than both the raw sensor data and the encoded data of use application 820. Accordingly, the bandwidth, transmission power, and/or the storage space used by the wearable devices 831 may be further reduced with respect to the wearable devices 821.

Although use application 830 is presented as a variation of use application 820, embodiments are not limited thereto, and use application 830 can be similarly modified to use quantized versions of the distillation encoders 112.

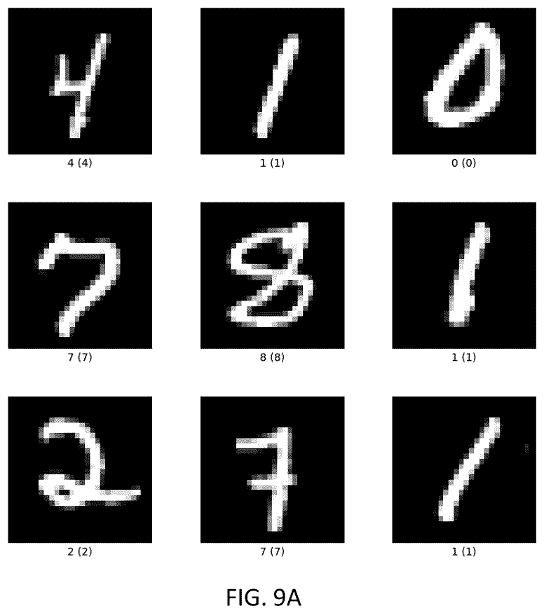

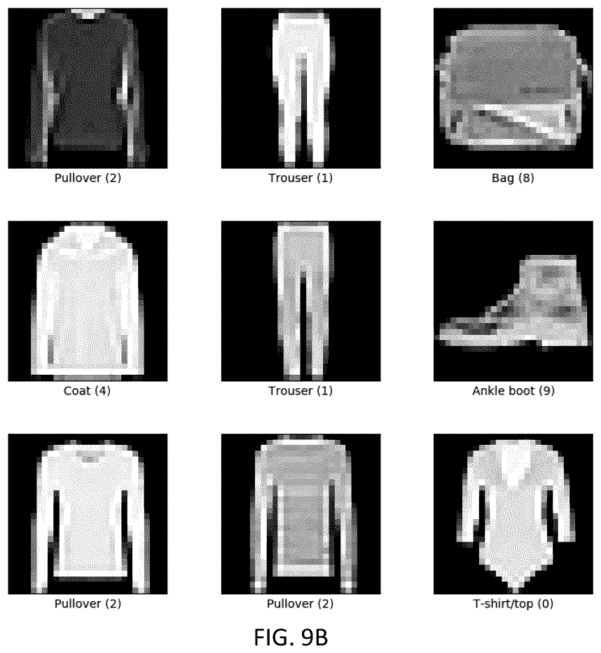

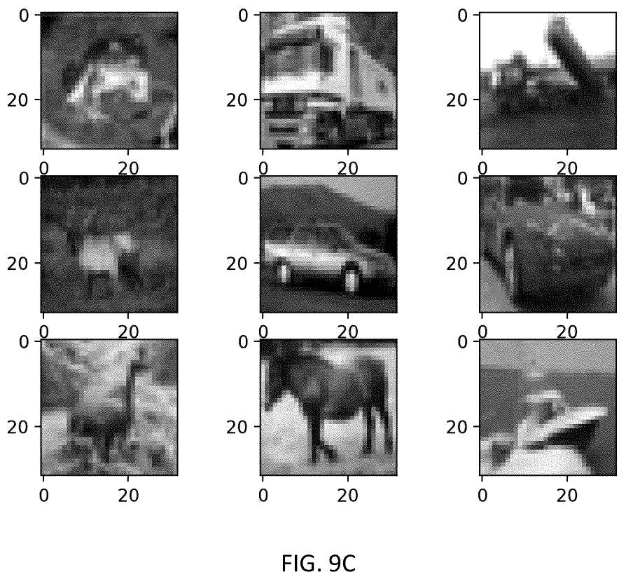

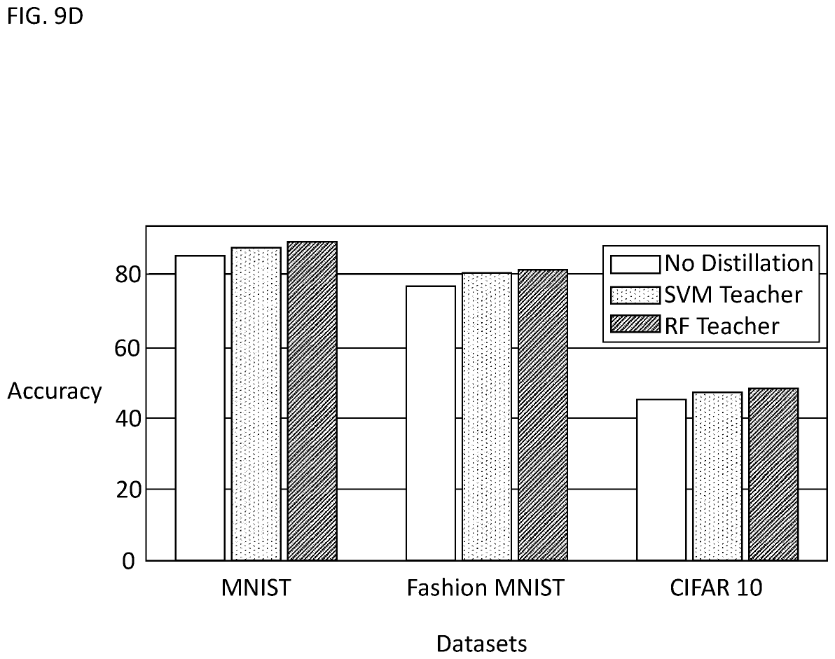

FIGS. 9A to 9C illustrate example data sets used to test a distillation encoder and an inference model according to embodiments. In particular, FIG. 9A illustrates an example of data from the Modified National Institute of Standards and Technology (MNIST) database, FIG. 9B illustrates an example of data from the Fashion-MNIST database, and FIG. 9C illustrates data from the Canadian Institute for Advanced Research (CIFAR)-10 database. Table 1 below shows the size, dimensions, and number of classes in each dataset, and the size of the testing set used to test the distillation encoder and the inference model according to embodiments.

TABLE 1

| Dataset | MNIST | Fashion-MNIST | CIFAR10 |
|---|---|---|---|
| Training set size | 50000 | 5000 | 50000 |
| Testing set size | 1000 | 1000 | 1000 |
| Dimensions | 28 × 28 | 28 × 28 | 32 × |
| | | | 32 × 3 |
| Number of Classes | 10 | 10 | 10 |

For the MNIST and Fashion-MNIST dataset, the distillation encoder and the inference model according to embodiments were trained using a teacher model including two rectified linear unit (ReLU)-activated hidden layers with 200 and 100 nodes, in which each layer was followed by a dropout layer with a 0.2 rate. For the CIFAR10 dataset, the distillation encoder and the inference model according to embodiments were trained using a teacher model having a convolutional neural network-based architecture including three visual geometry group (VGG) blocks, with 32, 64, and 128 filters for each block. For the CIFAR10 teacher model, the layers were initialized using He initialization, and ReLU activation was used for each layer.

For each of the datasets, an inference model including a one-layer classifier and a distillation encoder including a one-layer classifier was used. Stochastic gradient descent (SGD) was performed with a learning rate=0.001 and 0.9 momentum has been used to optimize the Cross-entropy loss function. The output layer of all models was a Softmax layer with the number of nodes equals the number of classes.

Table 2 shows an example of the accuracy gain obtained by using the distillation encoder and the inference model according to embodiments, and Table 3 shows an example of the accuracy gain obtained by using the quantized distillation encoder and the inference model according to embodiments. As can be seen from Table 2 and Table 3, using the distillation encoder and the inference model according to embodiments may lead to considerable accuracy gain.

TABLE 2

| | | | Accuracy |
|---|---|---|---|
| Dataset | Baseline | DE/IM | gain/loss |
| MNIST | 80.86% | 85.65% | +4.79% |
| Fashion-MNIST | 67.05% | 69.11% | +2.06% |
| CIFAR10 | 42.03% | 44.37% | +2.34% |

TABLE 3

| | | Quantized | Accuracy |
|---|---|---|---|
| Dataset | Baseline | DE/IM | gain/loss |
| MNIST | 93.9% | 95.7% | +1.8% |
| Fashion-MNIST | 84.8% | 86.5% | +1.7% |
| CIFAR10 | 53.3% | 55.4% | +2.1% |

FIG. 9D illustrates example results of using a distillation encoder and an inference model to perform classification tasks according to embodiments. In addition, FIG. 9D illustrates the results obtained after distilling from two non-neural network teacher models, in particular an SVM teacher model and an RF teacher model.

The results presented above with respect to FIGS. 9A-9D and Table 1, Table 2, and Table 3 are presented only as examples, and embodiments are not limited thereto.

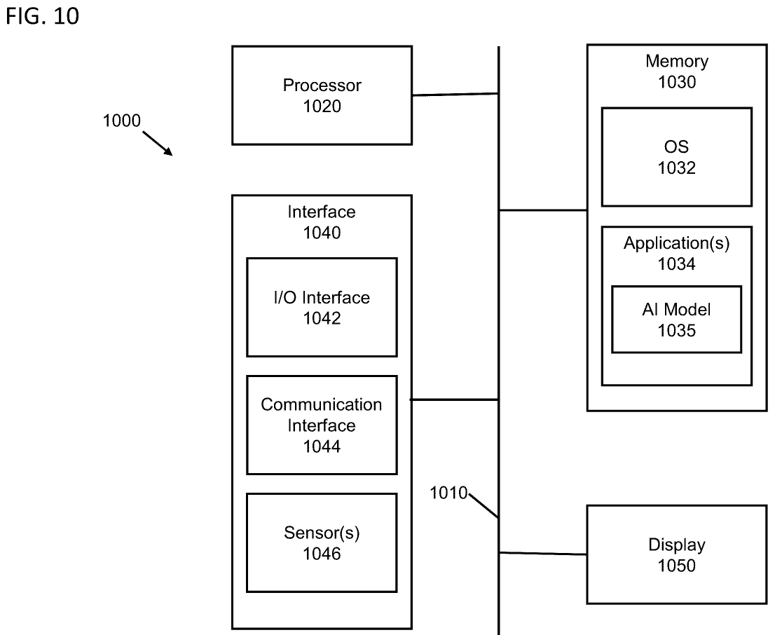

FIG. 10 is a block diagram of an electronic device according to embodiments.

FIG. 10 is for illustration only, and other embodiments of the electronic device 1000 could be used without departing from the scope of this disclosure. For example, the electronic device 1000 may correspond to at least one of the sensor node 110 and the fusion center 120.

The electronic device 1000 includes a bus 1010, a processor 1020, a memory 1030, an interface 1040, and a display 1050.

The bus 1010 includes a circuit for connecting the components 1020 to 1050 with one another. The bus 1010 functions as a communication system for transferring data between the components 1020 to 1050 or between electronic devices.

The processor 1020 includes one or more of a central processing unit (CPU), a graphics processor unit (GPU), an accelerated processing unit (APU), a many integrated core (MIC), a field-programmable gate array (FPGA), or a digital signal processor (DSP). The processor 1020 is able to perform control of any one or any combination of the other components of the electronic device 1000, and/or perform an operation or data processing relating to communication. For example, the processor 1020 may perform operations of the process 610 illustrated in FIG. 6A, the process 620 illustrated in FIG. 6B, and the process 700 illustrated in FIG. 7. The processor 1020 executes one or more programs stored in the memory 1030.

The memory 1030 may include a volatile and/or non-volatile memory. The memory 1030 stores information, such as one or more of commands, data, programs (one or more instructions), applications 1034, etc., which are related to at least one other component of the electronic device 1000 and for driving and controlling the electronic device 1000. For example, commands and/or data may formulate an operating system (OS) 1032. Information stored in the memory 1030 may be executed by the processor 1020.

The applications 1034 include the above-discussed embodiments. These functions can be performed by a single application or by multiple applications that each carry out one or more of these functions. For example, the applications 1034 may include artificial intelligence (AI) models for performing operations of the process 610 illustrated in FIG. 6A, the process 620 illustrated in FIG. 6B, and the process 700 illustrated in FIG. 7. Specifically, the applications 1034 may include at least one of a distillation encoder and an inference model according to embodiments of the disclosure.

The display 1050 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 1040 includes input/output (I/O) interface 1042, communication interface 1044, and/or one or more sensors 1046. The I/O interface 1042 serves as an interface that can, for example, transfer commands and/or data between a user and/or other external devices and other component(s) of the electronic device 1000.

The communication interface 1044 may include a transceiver to enable communication between the electronic device 1000 and other external devices (e.g., a sensor node or a fusion center), via a wired connection, a wireless connection, or a combination of wired and wireless connections. The communication interface 1044 may permit the electronic device 1000 to receive information from another device and/or provide information to another device. For example, the communication interface 1044 may include an Ethernet interface, an optical interface, a coaxial interface, an infrared interface, a radio frequency (RF) interface, a universal serial bus (USB) interface, a Wi-Fi interface, a cellular network interface, or the like.

The transceiver of the communication interface 1044 may include a radio frequency (RF) circuitry and a baseband circuitry.

The baseband circuitry may transmit and receive a signal through a wireless channel, and may perform band conversion and amplification on the signal. The RF circuitry may up-convert a baseband signal provided from the baseband circuitry into an RF band signal and then transmits the converted signal through an antenna, and down-converts an RF band signal received through the antenna into a baseband signal. For example, the RF circuitry may include a transmission filter, a reception filter, an amplifier, a mixer, an oscillator, a digital-to-analog converter (DAC), and an analog-to-digital converter (ADC).

The transceiver may be connected to one or more antennas. The RF circuitry of the transceiver may include a plurality of RF chains and may perform beamforming. For the beamforming, the RF circuitry may control a phase and a size of each of the signals transmitted and received through a plurality of antennas or antenna elements. The RF circuitry may perform a downlink multi-input and multi-output (MIMO) operation by transmitting one or more layers.

The baseband circuitry may perform conversion between a baseband signal and a bitstream according to a physical layer standard of the radio access technology. For example, when data is transmitted, the baseband circuitry generates complex symbols by encoding and modulating a transmission bitstream. When data is received, the baseband circuitry reconstructs a reception bitstream by demodulating and decoding a baseband signal provided from the RF circuitry.

The sensor(s) 1046 of the interface 1040 can meter a physical quantity or detect an activation state of the electronic device 1000 and convert metered or detected information into an electrical signal. For example, the sensor(s) 1046 can include one or more cameras or other imaging sensors for capturing images of scenes. The sensor(s) 1046 can also include any one or any combination of a microphone, a keyboard, a mouse, and one or more buttons for touch input. The sensor(s) 1046 can further include an inertial measurement unit. In addition, the sensor(s) 1046 can include a control circuit for controlling at least one of the sensors included herein. Any of these sensor(s) 1046 can be located within or coupled to the electronic device 1000.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 1000, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device 1000.

A model related to the neural networks described above may be implemented via a software module. When the model is implemented via a software module (for example, a program module including instructions), the model may be stored in a computer-readable recording medium.

Also, the model may be a part of the electronic device 1000 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method of managing sensor data, the method comprising:
receiving encoded data at a first device from a second device separate from the first device, wherein the encoded data is generated using an artificial intelligence (AI) encoder model included in the second device based on sensor data collected by at least one sensor included in the second device;
providing the encoded data to an AI inference model to obtain inference information; and
performing a task based on the inference information,
wherein the AI encoder model and the AI inference model are jointly trained based on an output of an AI teacher model.

2. The method of claim 1, wherein a size of the AI inference model is smaller than a size of the AI teacher model.

3. The method of claim 1, wherein a size of the encoded data is smaller than a size of the sensor data.

4. The method of claim 1, further comprising:
obtaining a plurality of pieces of encoded data at the first device from a plurality of second devices which are separate from the first device, wherein the plurality of pieces of encoded data are generated using a plurality of AI encoder models included in the plurality of second devices; and
combining the plurality of pieces of encoded data with the encoded data to generate aggregated data,
wherein the inference information is generated by the AI inference model based on the aggregated data, and
wherein the plurality of AI encoder models are jointly trained with the AI encoder model and the AI inference model based on the output of the AI teacher model.

5. The method of claim 4, wherein the encoded data is quantized by the AI encoder model before being transmitted to the first device.

6. The method of claim 1, wherein the second device comprises a surveillance camera as the at least one sensor, and
wherein the task comprises detecting at least one of an object and an event observed by the surveillance camera.

7. The method of claim 1, wherein the second device comprises a wearable device, and
wherein the task comprises detecting a health event associated with a user wearing the wearable device.

8. The method of claim 1, wherein the second device comprises an internet of things (IoT) device, and
wherein the encoded data is received using massive machine-type communications (mMTC).

9. The method of claim 1, wherein the AI inference model comprises a first neural network model, and
wherein the AI teacher model comprises at least one from among a second neural network model, a support vector machine (SVM) model, and an ensemble model.

10. A device for managing sensor data, the device comprising:
at least one memory storing computer-readable instructions; and
at least one processor configured to execute the computer-readable instructions to:
receive encoded data at a first device from a second device separate from the first device, wherein the encoded data is generated using an artificial intelligence (AI) encoder model included in the second device based on sensor data collected by at least one sensor included in the second device,
provide the encoded data to an AI inference model to obtain inference information, and
perform a task based on the inference information,
wherein the AI encoder model and the AI inference model are jointly trained based on an output of an AI teacher model.

11. The device of claim 10, wherein a size of the AI inference model is smaller than a size of the AI teacher model.

12. The device of claim 10, wherein a size of the encoded data is smaller than a size of the sensor data.

13. The device of claim 10, wherein the at least one processor is further configured to execute the computer-readable instructions to:
obtain a plurality of pieces of encoded data at the first device from a plurality of second devices which are separate from the first device, wherein the plurality of pieces of encoded data are generated using a plurality of AI encoder models included in the plurality of second devices, and
combine the plurality of pieces of encoded data with the encoded data to generate aggregated data,
wherein the inference information is generated by the AI inference model based on the aggregated data, and
wherein the plurality of AI encoder models are jointly trained with the AI encoder model and the AI inference model based on the output of the AI teacher model.

14. The device of claim 13, wherein the encoded data is quantized by the AI encoder model before being transmitted to the first device.

15. The device of claim 10, wherein the second device comprises a surveillance camera as the at least one sensor, and
wherein the task comprises detecting at least one of an object and an event observed by the surveillance camera.

16. The device of claim 10, wherein the second device comprises a wearable device, and
wherein the task comprises detecting a health event associated with a user wearing the wearable device.

17. The device of claim 10, wherein the second device comprises an internet of things (IoT) device, and
wherein the encoded data is received using massive machine-type communications (mMTC).

18. The device of claim 10, wherein the AI inference model comprises a first neural network model, and
wherein the AI teacher model comprises at least one from among a second neural network model, a support vector machine (SVM) model, and an ensemble model.

19. A non-transitory computer-readable storage medium storing instructions which, when executed by at least one processor of a device for managing sensor data, causes the at least one processor to:
receive encoded data at a first device from a second device separate from the first device, wherein the encoded data is generated using an artificial intelligence (AI) encoder model included in the second device based on sensor data collected by at least one sensor included in the second device;
provide the encoded data to an AI inference model to obtain inference information; and
perform a task based on the inference information,
wherein the AI encoder model and the AI inference model are jointly trained based on an output of an AI teacher model.

20. The non-transitory computer-readable storage medium of claim 19, wherein a size of the AI inference model is smaller than a size of the AI teacher model, and
wherein a size of the encoded data is smaller than a size of the sensor data.
